(19) United States
(12) Patent Application Publication
(10) Pub. No.: US 2018/0313398 A1
(43) Pub. Date: Nov. 1, 2018

(54) MULTI-COMPONENT DRIVESHAFT

(71) Applicant: UNIVERSITY OF WYOMING, Laramie, WY (US)

(72) Inventors: Kyle KUHN, Laramie, WY (US); Christian RUNDBERG, Laramie, WY (US)

(21) Appl. No.: 15/963,470

(22) Filed: Apr. 26, 2018

Related U.S. Application Data
(60) Provisional application No. 62/491,934, filed on Apr. 28, 2017.

(51) Int. Cl. F16C 3/02; B29C 70/32

(52) U.S. Cl. CPC F16C 3/023; B29K 2307/04; B29C 70/32; F16C 3/026

(57) ABSTRACT

A multi-component driveshaft includes a shaft and a power coupling. The shaft includes a plurality of layers formed from a continuous fiber with a protrusion positioned upon an interior surface at an end of the shaft. The power coupling includes a relief pocket and the power coupling is coupled to the shaft with the protrusion received within the relief pocket.

### CROSS-REFERENCE TO RELATED APPLICATIONS

### Field

This application claims benefit of U.S. provisional patent application Ser. No. 62/491,934, filed Apr. 28, 2017, which is herein incorporated by reference in its entirety.

### BACKGROUND

### Field

Embodiments of the present disclosure generally relate to a multi-component shaft and methods of manufacturing the same. More specifically, embodiments of the present disclosure relate to a multi-component drive shaft for use in the transportation industry and other industries.

### Description of the Related Art

As is common in the transportation industry, power or torque from an engine is transmitted to a transmission or other component using a shaft. The shaft is generally referred to as a driveshaft, a driveline, a jackshaft, or by other names, which may depend on the specific application of the shaft. These shafts often become significantly heavy to meet the power and durability requirements for transmitting the necessary torque, such as within a vehicle. Further, the heavier the shaft, the more engine power must be used to rotate the shaft due to the large moment of inertia of the shaft. This, in turn, creates inefficiencies in the use of the shaft and the drivetrain of the vehicle, thereby limiting the available acceleration and top velocity of the vehicle and engine while also reducing fuel economy.

The weight of a driveshaft can be reduced by using different types of materials, such as a fiber reinforced composite tube, which can span the majority of the length of the driveshaft. The composite tube is generally fabricated, cured, and cut to length in a first processing operation, with power or transmission couplings attached to either end of the composite tube in a post processing operation. The couplings are bonded and/or pinned to the composite laminate of the composite tube. Cutting the composite tube, however, can induce edge defects to the composite tube in addition to exposing the layers of the composite tube to moisture and other contaminants. Pinning the composite tube to the couplings can separately introduce stress concentrations into the shaft. Further, to ensure proper bonding between the couplings and the shaft, the couplings and the shaft are aligned with each other to ensure concentricity of the driveshaft and reduce runout and vibration under high rotational velocities. The bond line between the shaft and the couplings must also have a uniform thickness for concentricity of the driveshaft.

Thus, what is needed in the art is an improved multi-component driveshaft and a method of manufacturing the same, particularly for use in the transportation industry.

### SUMMARY

Embodiments disclosed herein relate to apparatus and methods for a multi-component driveshaft.

In one embodiment, a multi-component driveshaft is disclosed that includes a shaft and a power coupling. The shaft includes a plurality of layers formed from a continuous fiber with a protrusion positioned upon an interior surface at an end of the shaft. The power coupling includes a relief pocket and the power coupling is coupled to the shaft with the protrusion received within the relief pocket.

In another embodiment, a collapsible mandrel to manufacture a multi-component driveshaft is disclosed. The mandrel includes a mandrel core and a mandrel shell positioned about the mandrel core with the mandrel shell including a plurality of segments. At least one of the plurality of segments includes an interior side proximal the mandrel core and an exterior side distal the mandrel core with the interior side having a surface area or width larger than a surface area or width of the exterior side.

In yet another embodiment, a method of manufacturing a multi-component driveshaft is disclosed. The method includes positioning a first power coupling and a second power coupling over a mandrel, applying an adhesive layer to ends of each of the first power coupling and the second power coupling, winding a continuous fiber between the first power coupling and the second power coupling and over the adhesive layers to form a shaft comprising a plurality of layers from the continuous fiber, and curing the shaft on the first power coupling and the second power coupling to form the multi-component driveshaft.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a side view of a driveshaft in accordance with one or more embodiments of the present disclosure.

FIG. 2 is a cross-sectional view of a driveshaft in accordance with one or more embodiments of the present disclosure.

FIG. 3 is a side view of a power coupling in accordance with one or more embodiments of the present disclosure.

FIG. 4 is a cross-sectional view of a shaft coupled with a power coupling in accordance with one or more embodiments of the present disclosure.

FIG. 5 is a perspective view of a collapsible mandrel in accordance with one or more embodiments of the present disclosure.

FIG. 6 is a cross-sectional view of a collapsible mandrel in accordance with one or more embodiments of the present disclosure.

FIG. 7 is a perspective view of power couplings positioned upon a mandrel in accordance with one or more embodiments of the present disclosure.

FIG. 8 is a cross-sectional view of a power coupling positioned upon a mandrel in accordance with one or more embodiments of the present disclosure.

FIG. 9 is a side view of a driveshaft formed upon a mandrel in accordance with one or more embodiments of the present disclosure.

FIG. 10 is a cross-sectional view of a driveshaft formed upon a mandrel in accordance with one or more embodiments of the present disclosure.

FIG. 11 is a side view of a multi-component driveshaft on a collapsible mandrel in accordance with one or more embodiments of the present disclosure.

FIG. 12 is a cross-sectional view of a multi-component driveshaft on a collapsible mandrel in accordance with one or more embodiments of the present disclosure.

FIG. 13 is a side view of support members positioned between power couplings in accordance with one or more embodiments of the present disclosure.

FIG. 14 is a perspective view of a power coupling in accordance with one or more embodiments of the present disclosure.

FIG. 15 is a sectional perspective view of a driveshaft formed about a mandrel in accordance with one or more embodiments of the present disclosure.

FIG. 16 is a perspective view of a driveshaft with track drivers in accordance with one or more embodiments of the present disclosure.

FIG. 17 illustrates a perspective view of supports used within a multi-component driveshaft in accordance with one or more embodiments of the present disclosure.

FIG. 18 is a flowchart of a method to manufacture a multi-component driveshaft in accordance with one or more embodiments of the present disclosure.

To facilitate understanding, identical reference numerals have been used, where possible, to designate identical elements that are common to the figures. It is contemplated that elements disclosed in one embodiment may be beneficially utilized with other embodiments without specific recitation.

### DETAILED DESCRIPTION

Embodiments of the present disclosure relate to a multi-component driveshaft, such as for transmitting torque and power within a vehicle in the transportation industry. The driveshaft includes a shaft having a plurality of layers formed from a continuous fiber and a protrusion positioned upon an interior surface at an end of the shaft. The driveshaft further includes a power coupling with a relief pocket that is coupled to the shaft with the protrusion received within the relief pocket.

In one or more embodiments of the present disclosure, a collapsible mandrel is used to manufacture the multi-component driveshaft. The mandrel includes a mandrel core and a mandrel shell with a plurality of segments that are positioned about the mandrel core. The mandrel core is insertable into and removable from the mandrel shell. When the mandrel core is removed from the mandrel shell, the mandrel shell segments are collapsible upon themselves to facilitate removal from the interior of the driveshaft. As such, at least one of the plurality of segments of the mandrel shell includes an interior side that is proximal the mandrel core, an exterior side that is distal the mandrel core, and a tapered edge extending between the interior side and the exterior side such that the interior side of the segment is larger (e.g., larger in width or surface area) than the exterior side of the segment.

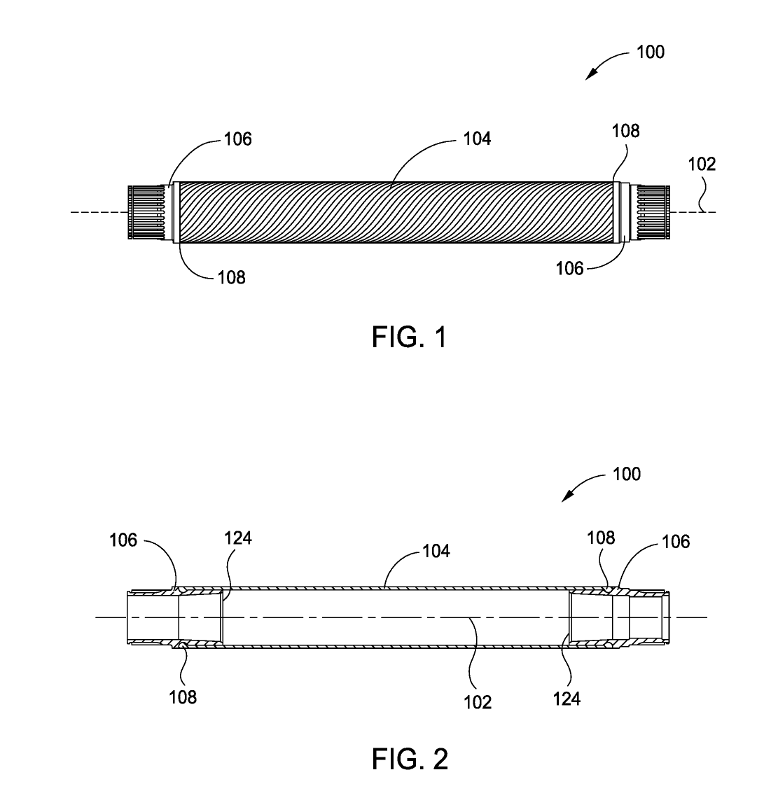

FIGS. 1 and 2 provide multiple views of a multi-component driveshaft 100 in accordance with one or more embodiments of the present disclosure. FIG. 1 is a side view of the driveshaft 100, and FIG. 2 is a cross-sectional view of the driveshaft 100. The driveshaft 100 has an axis 102 defined or extending therethrough and includes a shaft 104 with power couplings 106 coupled or attached to each end 108 of the shaft 104. The shaft 104 is a fiber-reinforced composite shaft that includes multiple layers formed from a continuous fiber or bundle of fibers. For example, a fiber (or bundle of fibers) is wrapped or layered over ends 124 of the couplings 106 and between the couplings 106 to form the shaft 104. As the fiber is positioned over and between the couplings 106 when forming the shaft 104, the fiber is continuous or non-segmented amongst and between the layers of the shaft 104. Otherwise, if the ends 108 of the shaft 104 are cut, such as to later facilitate coupling or bonding the shaft 104 to the couplings 106, the fiber used to form the shaft 104 would not be continuous and would be segmented from one layer to the next within the shaft 104. Thus, in one embodiment, a single fiber (or a single bundle of fibers) may be used to form the shaft 104 with the fiber continuous and non-segmented across each of the layers of the shaft 104.

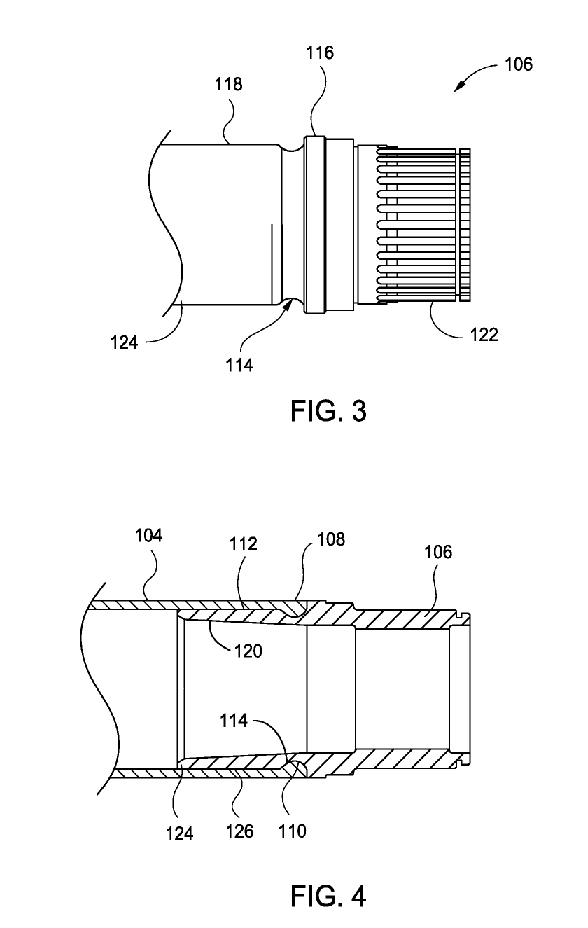

FIGS. 3 and 4 illustrate multiple views of the power coupling 106 and the end 108 of the shaft 104 in accordance with one or more embodiments of the present disclosure. FIG. 3 is a side view of the power coupling 106, and FIG. 4 is a cross-sectional view of the shaft 104 coupled with the power coupling 106. The shaft 104 includes a protrusion 110 positioned on an interior surface 112 of the shaft 104 and at the end 108 of the shaft 104. Further, the power coupling 106 includes a relief pocket 114 sized and positioned such that the protrusion 110 of the shaft 104 is received within the relief pocket 114. When forming the shaft 104, the fiber may be wound or positioned within the relief pocket 114 to form the protrusion 110 and facilitate connection between the shaft 104 and the power coupling 106. Thus, the protrusion 110 may be formed from the continuous fiber (or bundle of fibers) that is used to form the shaft 104. Additionally, though only one end 108 of the shaft 104 is shown in FIG. 4, both ends 108 of the shaft 104 may have a similar engagement with a power coupling 106 to facilitate connection between the shaft 104 and the power coupling 106.

In addition to the relief pocket 114, the power coupling 106 includes a collar 116 and a non-tapered exterior surface 118. The relief pocket 114 is positioned between the collar 116 and the non-tapered exterior surface 118 such that the relief pocket 114 has a smaller radius (or width if a non-circular cross section for the power coupling 106, discussed more below) than the collar 116 and/or the non-tapered exterior surface 118. The end 108 of the shaft 104 is positioned over the non-tapered exterior surface 118 of the power coupling 106 for the protrusion 110 to be formed and positioned within the relief pocket 114.

To facilitate bonding or coupling between the shaft 104 and the power coupling 106, an adhesive 126 is positioned between the shaft 104 and the power coupling 106. For example, the adhesive 126 is positioned or layered between the protrusion 110 and/or the interior surface 112 of the shaft 104 and the relief pocket 114 and/or the non-tapered exterior surface 118 of the power coupling 106. The power coupling 106 also includes a tapered interior surface 120 to facilitate positioning of the power coupling 106 on a mandrel (discussed more below) when manufacturing the driveshaft 100. Further, the power coupling 106 includes splines 122 to facilitate transmitting torque from the driveshaft 100 through the power coupling 106. For example, the splines 122 are ridges or teeth formed in the power coupling 106 that engage with grooves in a mating component to transfer torque to and from the driveshaft 100 through the power coupling 106. Additionally or alternatively, the power coupling 106 may include a yoke-type coupling, gears, and/or other features to facilitate transmitting torque from the driveshaft 100 through the power coupling 106.

As the shaft 104 is formed about the power coupling 106, the relief pocket 114 of the power coupling 106 may be used to define a depth, size, and/or shape of the protrusion 110 of the shaft 104. In one embodiment, the relief pocket 114 has a depth that is about 1 to about 1.5 times the thickness of the shaft 104, such as the thickness at a middle portion of the shaft 104 that does not overlap with the power coupling 106. In one embodiment, the protrusion 110 of the shaft 104 has a thickness that is about 2 to about 2.5 times the thickness of the remainder or the middle portion of the shaft 104. The protrusion 110 defines an increased thickness for the shaft 104, as the shaft 104 has a smaller inner diameter at the location of the protrusion 110 (compared to a middle portion of the shaft 104) to extend and protrude into the relief pocket 114. The engagement of the protrusion 110 with the relief pocket 114 facilitates connection between the shaft 104 and the power coupling 106, particularly in the axial direction of the driveshaft 100. Further, though the relief pocket 114 is shown as having an arcuate cross-section in this embodiment, the present disclosure is not so limited. For example, the relief pocket 114 may have other corresponding sizes or shapes, such as rectangular or polygonal, without departing from the scope of the present disclosure.

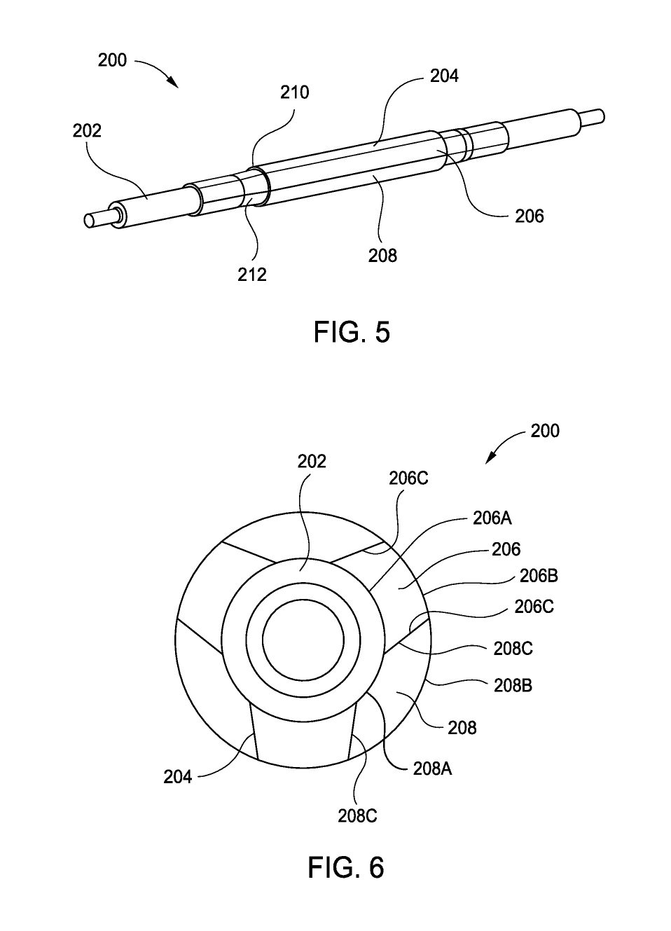

Referring now to FIGS. 5 and 6, multiple views of a collapsible mandrel 200 in accordance with one or more embodiments of the present disclosure are shown. FIG. 5 is a perspective view of the collapsible mandrel 200, and FIG. 6 is a cross-sectional view of the collapsible mandrel 200. In one or more embodiments, the collapsible mandrel 200 is used to manufacture the multi-component driveshaft 100. For example, the power couplings 106 are positioned on the mandrel 200. The fiber (or bundle of fibers) is then wound over the ends 124 of the power couplings 106 and over the portion of the mandrel 200 between the couplings 106 to form the shaft 104. After curing (such as through a heating or annealing process), the mandrel 200 is collapsed and removed from the interior of the driveshaft 100.

The collapsible mandrel 200 includes a mandrel core 202 with a mandrel shell 204 positioned about the mandrel core 202. The mandrel core 202 is insertable into and removable from the mandrel shell 204. The mandrel shell 204 includes a plurality of segments 206 and 208 that are positioned about the mandrel core 202 to form the shell 204. The segments 206 and 208 are collapsible upon themselves when the mandrel core 202 is not positioned within the mandrel shell 204 to facilitate removal of the mandrel shell 204 from the interior of the driveshaft 100.

To facilitate the movement and the collapsing, the segments 206 and 208 have different but corresponding or complementing edges or shapes with respect to each other. For example, the segments 206, or at least one of the segments 206, has an interior side 206A positioned proximal the mandrel core 202 and an exterior side 206B positioned distal the mandrel core 202. The interior side 206A of the segment 206 is larger, such as in width or in surface area, than the exterior side 206B. The segment 206 includes one or more tapered edges 206C that extend between the interior side 206A and the exterior side 206B to define the larger size for the interior side 206A over the exterior side 206B. By having the segment 206 include a larger or wider interior side 206A over the exterior side 206B, and/or by having a tapered edge 206C, the segment 206 may be moved or pushed inward, such as with respect to the segments 208 when the mandrel core 202 is not present. The collapsible arrangement of the segments 206 facilitates removal of the segments 206 from the interior of the driveshaft 100 after the mandrel core 202 has been removed.

Further, the mandrel shell 204 includes segments 208 to complement the segments 206. In particular, the segments 208, or at least one of the segments 208, has an interior side 208A positioned proximal the mandrel core 202 and an exterior side 208B positioned distal the mandrel core 202. The interior side 208A of the segment 208 is larger, such as in width or in surface area, than the exterior side 208B. The segment 208 also includes one or more tapered edges 208C that extend between the interior side 208A and the exterior side 208B to define the smaller size for the interior side 208A over the exterior side 208B. The tapered edge 208C of the segment 208 abuts the tapered edge 206C of the segment 206. When collapsing the mandrel 200, after the mandrel core 202 has been removed from the mandrel shell 204, the segment 208 is removed from the interior of the driveshaft 100 after the segment 206 has been removed.

In one or more embodiments, the mandrel 200 may include a collar 210 and/or a tapered outer surface 212. For example, the mandrel shell 204 is shown as including the collar 210 and the tapered outer surface 212 with the collar 210 and the tapered outer surface 212 formed adjacent to each other. The collar 210 and/or the tapered outer surface 212 are used to facilitate placement and positioning of the power couplings 106 upon the mandrel 200.

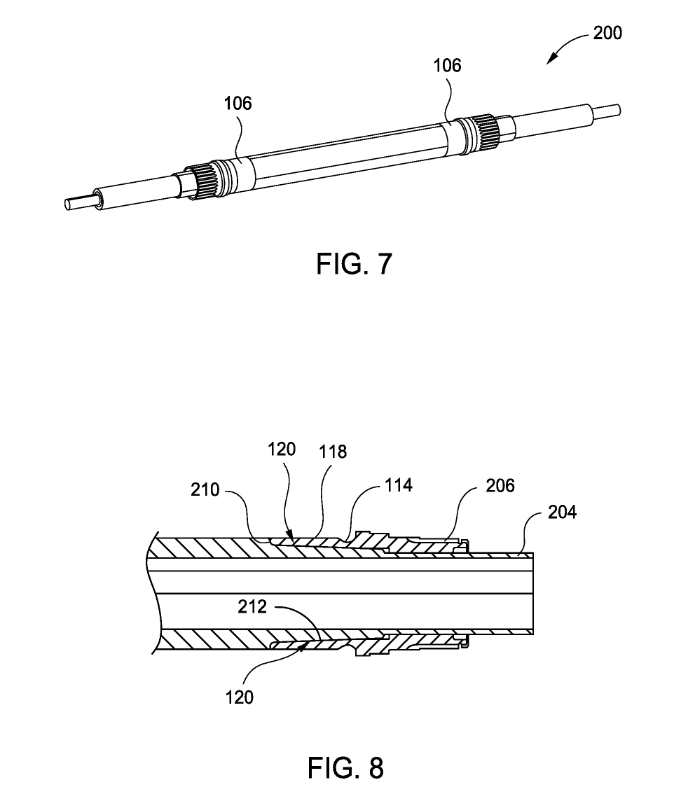

FIGS. 7 and 8 illustrate multiple views of the power couplings 106 positioned upon the mandrel 200 in accordance with one or more embodiments of the present disclosure. FIG. 7 is a perspective view with the power couplings 106 positioned upon the mandrel 200, and FIG. 8 is a cross-sectional view of the power couplings 106 positioned upon the mandrel 200. When manufacturing the driveshaft 100, the power couplings 106 are positioned on the mandrel 200 and aligned with each other and/or the mandrel 200. In particular, the power couplings 106 are positioned on the mandrel 200 to abut the collars 210, and/or the tapered interior surface 120 of the power couplings 106 abut or engage the corresponding tapered outer surface 212 of the mandrel 200. The engagement of the power couplings 106 with the collar 210 and/or the tapered outer surface 212 may be used for axial and/or rotational positioning of the power couplings 106 with respect to each other and with respect to the mandrel 200.

Prior to winding the fiber (or bundle of fibers) onto the mandrel 200 and the power couplings 106, adhesive or an adhesive layer is applied to the couplings 106. The adhesive 126 is applied to the non-tapered exterior surface 118 and/or the relief pocket 114 of the power couplings 106. After the adhesive 126 is applied, the fiber is wound over the adhesive 126 at each of the ends 124 of the couplings 106 with the fiber extending between the couplings 106. In particular, a fiber or filament winding machine may be used to facilitate forming the driveshaft 100, such as on the mandrel 200. As the mandrel 200 is rotated, the machine with the fiber moves and traverses back and forth between the couplings 106 to form the shaft 104 on the couplings 106 and the mandrel 200. The fiber is wound around the adhesive 126 of one of the power couplings 106, such as within the relief pocket 114 and over the non-tapered exterior surface 118. The fiber is carried by the machine towards the other power coupling 106 with the fiber winding around the mandrel 200, and particularly the mandrel shell 204. The fiber then winds around the adhesive 126 of the other power coupling 106, such as within the relief pocket 114 and over the non-tapered exterior surface 118. After the fiber is wound around the other power coupling 106, the machine may then move and traverse back towards the initial power coupling 106 to continue winding the fiber around the mandrel 200 and the power couplings 106.

The shaft 104 is formed as a plurality of layers from the fiber as the fiber is wound around the mandrel 200 and the power couplings 106. In one embodiment, each pass of the fiber between the power couplings 106 forms a helical layer of fiber for the shaft 104. Further, the rotational velocity of the mandrel 200 and the translational velocity of the fiber or machine may be used to define the angle of the fiber within the helical layers of the shaft 104. In one embodiment, as the fiber makes a first pass between the power couplings 106, a helical layer is formed or disposed at an angle between 0° and 90° with respect to the axis 102 of the driveshaft 100, and more particularly, between 5° and 85° with respect to the axis 102 of the driveshaft 100. As the fiber then makes a second pass between the power couplings 106 in the opposite direction, a second helical layer is formed or disposed at an angle between 90° and 180° with respect to the axis 102 of the driveshaft 100, and more particularly, between 95° and 175° with respect to the axis 102 of the driveshaft 100. Further, during transition between layers, the fiber may accumulate, such as within the relief pocket 114 of the power coupling 106, to form the protrusion 110 at the end 108 of the shaft 104. Thus, as the fiber accumulates when transitioning between layers, the protrusion 110 may be formed to have an increased thickness, such as compared to the portion of the shaft 104 formed over the mandrel 200.

As discussed above, the shaft 104 includes fiber and is formed as a fiber-reinforced composite shaft. The fiber used within the shaft 104 includes carbon in one embodiment, though the present disclosure is not so limited. In another embodiment, the fiber includes glass and/or any other fiber known in the art. Further, the fiber is coated with resin, glue, or another adhesive prior to or when being wound to form the shaft 104. For example, the adhesive, such as resin, may be applied to the fiber by the machine during the winding process when forming the shaft 104. Additionally or alternatively, the fiber may be pre-impregnated such that adhesive is already on the fiber before the winding process. In such an embodiment, the pre-impregnated fiber may be heated before or during the winding process to facilitate the application of the fiber on the mandrel 200 and the power couplings 106 to form the shaft 104. The adhesive, once cured or hardened, results in a layer or coating on the fiber with the fiber and the adhesive forming a fiber-reinforced composite for the shaft 104. In one or more embodiments, the fiber-reinforced composite for the shaft 104 may include any type of fiber-reinforced polymer composite that includes any thermoset or thermoplastic polymer, and the adhesive, if resin, may include any thermoset resin, such as epoxy, polyester, or vinyl ester resin. Thus, the present disclosure contemplates multiple types of fiber and fiber-reinforced composite for the shaft 104 and is not limited to only those materials and composites identified above.

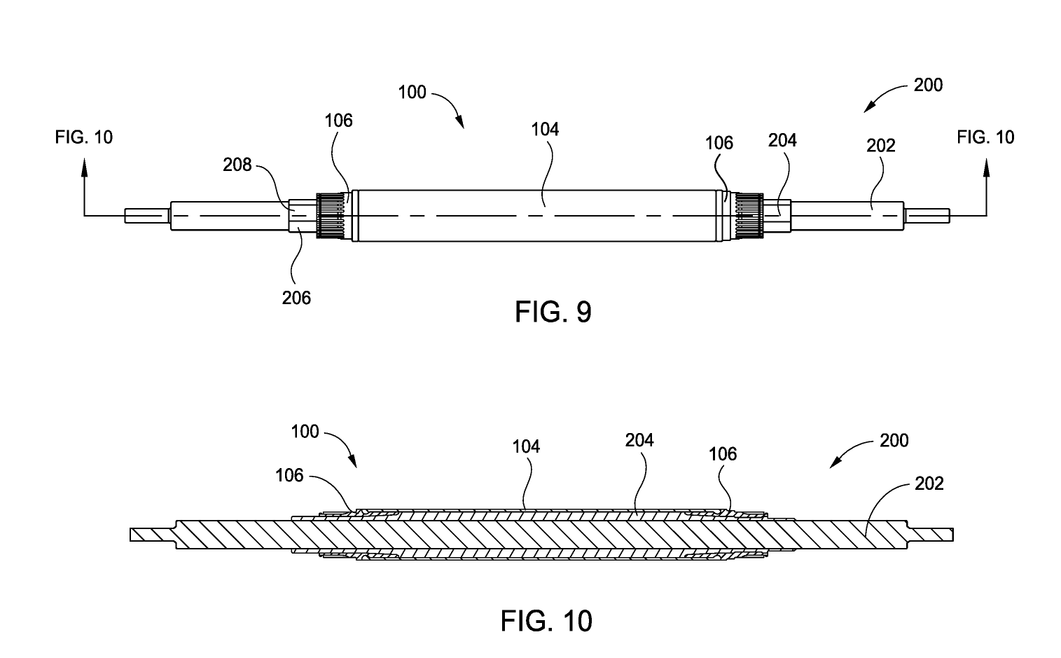

FIGS. 9 and 10 provide multiple views of the multi-component driveshaft 100 on the collapsible mandrel 200, such as during or after the manufacturing process of the driveshaft 100, in accordance with one or more embodiments of the present disclosure. FIG. 9 shows a side view of the driveshaft 100 formed upon the mandrel 200, and FIG. 10 shows a cross-sectional view of the driveshaft 100 formed upon the mandrel 200. Once the winding process of the fiber is complete, the mandrel 200, with the fiber and the power couplings 106, is hardened cured to form the driveshaft 100. In one embodiment, heat is used to cure and form the driveshaft 100. The mandrel 200 may be positioned within a heater or furnace to cure the adhesive to form the shaft 104. In one embodiment, the adhesive used between the shaft 104 and the power couplings 106 is a co-curing film adhesive. As such, the adhesive cures in the heater when the shaft 104 is curing.

Once the driveshaft 100 has been cured, the driveshaft 100 is removed from the mandrel 200. In the embodiment shown in FIGS. 9 and 10, in which the mandrel 200 is collapsible, the mandrel core 202 is removed from the interior of the driveshaft 100 and the mandrel shell 204. After the mandrel core 202 is removed, the mandrel shell 204 is subsequently removed from the interior of the driveshaft 100. In particular, as the ends of the segments 206 and 208 protrude from the ends of the driveshaft 100, the segments 206 and 208 are moved or pushed to internally collapse away from the driveshaft 100 as the mandrel core 202 no longer provides support to the segments 206 and 208 of the mandrel shell 204. The segments 206 and 208 are then removed from the interior of the driveshaft 100.

In the above embodiments, the driveshaft and related components are shown with a circular-shaped cross-section. For example, the shaft 104, the power couplings 106, and/or the mandrel 200 have a circular-shaped cross-section. However, the present disclosure is not so limited, as other shapes, such as a polygonal-shape, may be used for a cross-section of a driveshaft without departing from the scope of the present disclosure. For example, if using a polygonal-shape, the polygon may have six or eight sides, though the present disclosure is not so limited and may have more or less sides. Further, the polygonal-shape may have at least one axis of symmetry, though again, the present disclosure is not so limited.

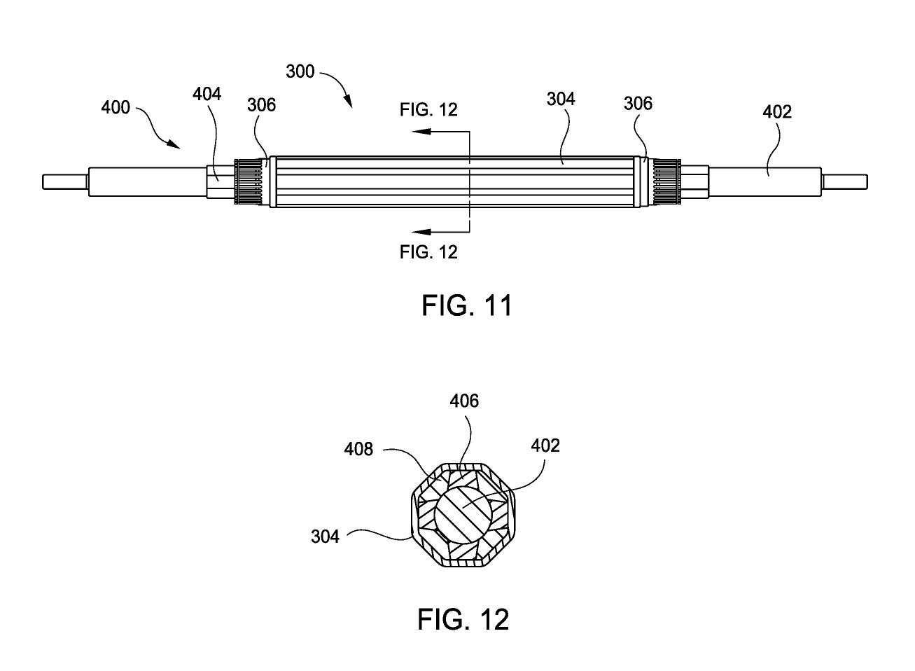

FIGS. 11 and 12 are multiple views of a multi-component driveshaft 300 on a collapsible mandrel 400 having a polygonal-shaped cross-section in accordance with one or more embodiments of the present disclosure. In this embodiment, a mandrel shell 404, which includes segments 406 and 408, has a polygonal-shaped cross-section to form a polygonal-shaped cross-section for a shaft 304 of the driveshaft 300. Further, ends (similar to the ends 124) of power couplings 306 received within the shaft 304 also have a polygonal-shaped cross-section. For example, though not shown, a relief pocket and a non-tapered exterior surface (similar to the relief pocket 114 and the non-tapered exterior surface 118) of the power couplings 306 have a polygonal-shaped cross-section. The mandrel core 402 also has a polygonal-shaped cross-section in one or more embodiments, but for purposes here is shown with a circular-shaped cross-section. The shaft 304 having a polygonal-shaped cross-section facilitates the transmission of torque or power, such as rotationally, across the sides of the polygonal-shaped cross-section.

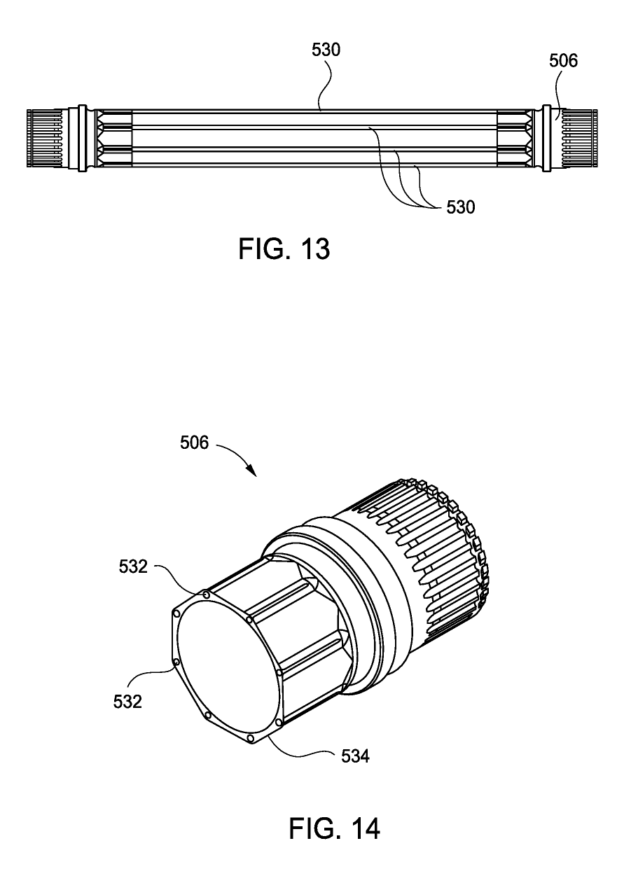

In one or more embodiments, in addition or in alternative to the collapsible mandrel 400, support members may be positioned within the driveshaft to facilitate manufacturing the driveshaft 300. FIGS. 13 and 14 illustrate multiple views of support members 530 positioned between power couplings 506, such as when manufacturing a driveshaft with a polygonal-shaped cross-section. The support members 530, which are shown as rods or any other similar shape, extend between each of the power couplings 506. In this embodiment, the power couplings 506 each have a plurality of holes 532 formed in ends 534 thereof with the holes 532 used to receive ends of the support members 530. Each hole 532 is formed at the intersection of polygonal sides of the power coupling 506, and may also be formed such that a support member 530, when received within the hole 532, is even or co-planar with the power coupling 506.

The co-planar position of the support member 530 relative to the power coupling 506 is contemplated to prevent an uneven transition or uneven surface for the shaft when winding the fiber around the support members 530 and the power couplings 506. A mandrel, which may or may not be collapsible, may optionally be used with the embodiment shown in FIGS. 13 and 14, such as for positioning the power couplings 506 on the mandrel prior to winding the fiber to form the shaft for the driveshaft 300. The mandrel may also be used to provide support to the support members 530 during the winding process, such as to prevent deflection of the support members 530. The support members 530, however, remain within the driveshaft after manufacturing, whereas the mandrel is removed after curing the driveshaft.

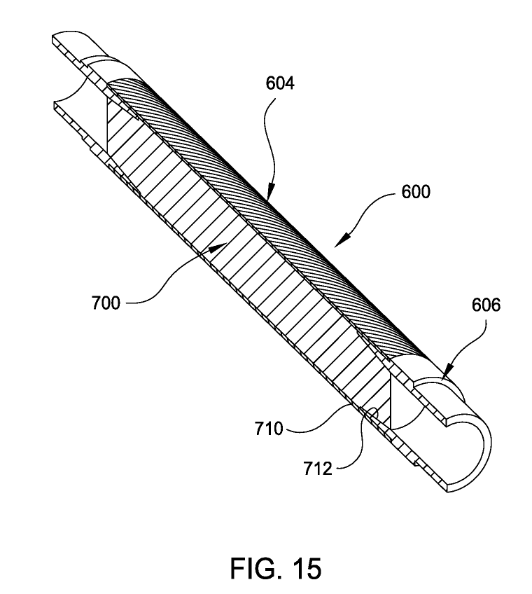

In the above embodiments, the mandrel is removed from the driveshaft after curing. However, the present disclosure is not so limited. FIG. 15 illustrates a sectional perspective view of a driveshaft 600 formed about a mandrel 700 with the mandrel 700 remaining in the driveshaft 600 after manufacturing and curing. In this embodiment, the mandrel 700 is formed from a lightweight or low density material, such as foam, as compared to metal or a heavier material for use in the above mandrel embodiments. The mandrel 700 includes a collar 710 and/or a tapered outer surface 712 to facilitate positioning of the power couplings 606 on the mandrel 700. After the fiber has been wound on the power couplings 606 and the mandrel 700 to form the shaft 604, the driveshaft 600 is cured with the mandrel 700. Further, after curing, the mandrel 700 remains within the driveshaft 600, as opposed to the above embodiments where the mandrel is collapsed and removed from the driveshaft.

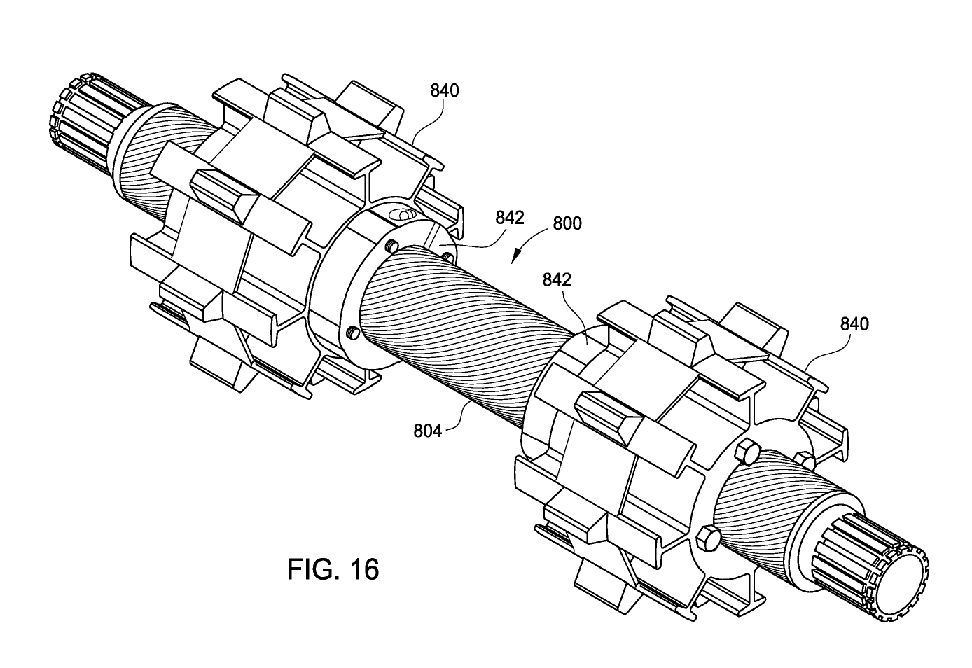

FIG. 16 illustrates a perspective view of a driveshaft 800 with one or more track drivers 840 in accordance with one or more embodiments of the present disclosure. The driveshaft 800 includes a shaft 804 with track drivers 840 positioned about the shaft 804. The track drivers 840 are used to facilitate transmission of torque or power from the driveshaft 800, through the track drivers 840, and to a track, such as for propelling a vehicle. The track drivers 840 are coupled to the shaft 804 directly in one embodiment. In another embodiment, the track drivers 840 are coupled to the shaft 804 through adapters 842. The adapters 842 are sized to fit onto and grip the shaft 804, thereby preventing rotation between the adapters 842 and the shaft 804. The track drivers 840 are coupled to the shaft 804 through the adapters 842.

Further, in one or more embodiments, one or more supports are positioned within the shaft 804, such as to provide support to the shaft 804 at the locations of the track drivers 840. A support is positioned at the axial location of a track driver 840, such as within the shaft 804, to axially overlap with the track driver 840. As the track driver 840 introduces a stress concentration to the shaft 804 through torque or power transmission between the track driver 840 and the shaft 804, the support is used to provide support to the shaft 804 at the location of the track driver 840 or the stress concentration.

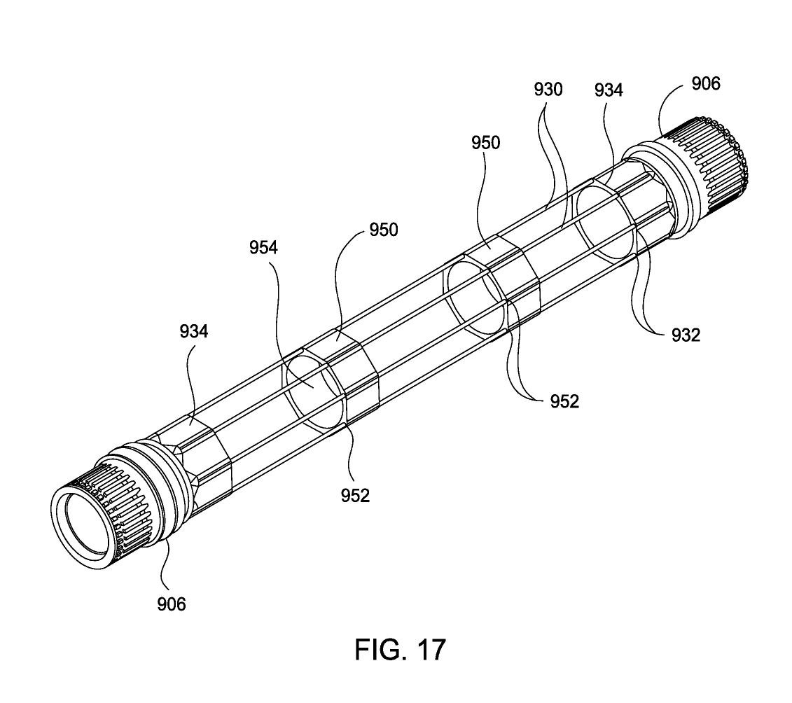

FIG. 17 illustrates a perspective view of supports 950 used within a multi-component driveshaft in accordance with one or more embodiments of the present disclosure. In FIG. 17, support members 930 extend between each of power couplings 906 with the ends of the support members 930 received within holes 932 formed in ends 934 of the power couplings 906. The supports 950 are positioned between the power couplings 906 and are coupled to the support members 930. In particular, the supports 950 in this embodiment include holes 952 formed therethrough to receive the support members 930. As such, the support members 930 are able to extend through the holes 952 of the supports 950. As with the holes 932 of the power coupling 906, each hole 952 is formed at the intersection of polygonal sides of the support 950, and may also be formed such that the support member 930, when received within the hole 952, is even or co-planar with the support 950 and the power coupling 906. The co-planar position of the support member 930 relative to the support 950 is contemplated to prevent an uneven transition or uneven surface for the shaft when winding the fiber around the support members 930 and the supports 950.

The supports 950 are positioned during the manufacturing process for the shaft at a desired axial location, such as to axially overlap with an anticipated stress concentration. The supports 950 have a polygonal-shaped cross-section corresponding to the polygonal-shaped cross-section of the power couplings 906. However, in the embodiment in FIG. 16, as the shaft 804 has a circular-shaped cross-section, a support for that embodiment may have a corresponding circular-shaped cross-section. The supports 950 also have a hole 954 formed through a center thereof axially to receive a mandrel therethrough. The supports 950 may then remain in place during the winding and curing process for manufacturing the driveshaft. After curing has been completed, the supports 950 may still remain within the driveshaft to provide support at the desired location, for example, at an anticipated location of stress concentrations for the driveshaft.

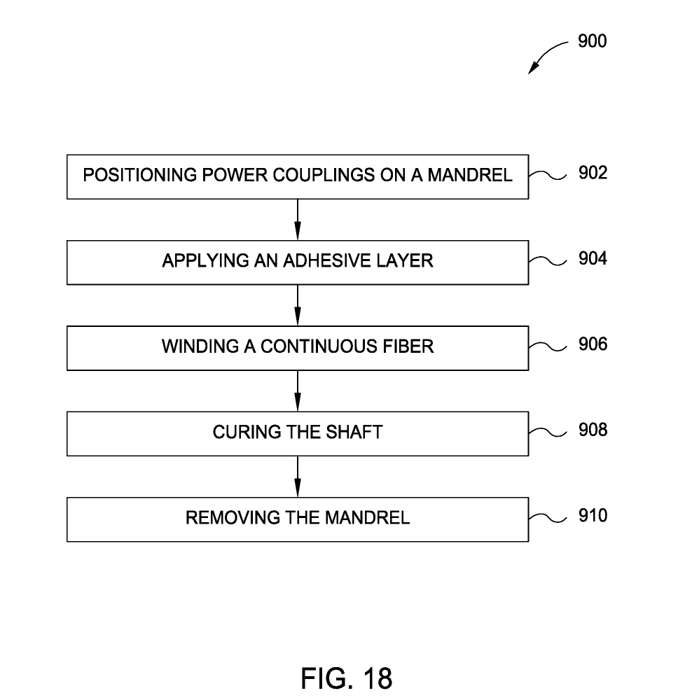

FIG. 18 illustrates a flowchart of a method 1000 to manufacture a multi-component driveshaft in accordance with one or more embodiments of the present disclosure. The method 1000 includes positioning power couplings on a mandrel in operation 1002 and applying an adhesive layer in operation 1004 to the ends of each of the power couplings. The method 1000 further includes winding a continuous fiber in operation 1006 between the power couplings and over the adhesive layers on the power couplings to form the shaft on the power couplings. The winding of the continuous fiber in operation 1006 involves moving the fiber back-and-forth between the power couplings to form multiple layers of the fiber for the shaft.

The method 1000 further includes curing the shaft in operation 1008 on the power couplings to form the driveshaft. The adhesive between the shaft and the power couplings is cured when curing the shaft to facilitate bonding between the shaft and the power couplings. Once cured, the method 1000 may include removing the mandrel in operation 1010 from the driveshaft. For example, if the mandrel is collapsible, the mandrel is removed in operation 1010 by removing the mandrel core from within the mandrel shell, and then removing the mandrel shell from within the shaft.

A driveshaft in accordance with the present disclosure provides one or more advantages or benefits. In one embodiment, a driveshaft is formed from a lightweight and a high strength material to reduce the weight and moment-of-inertia for the driveshaft without sacrificing strength and torque characteristics. In another embodiment, the driveshaft is formed to have an interference fit or lock to facilitate connection between the shaft and the power coupling. For example, the shaft and the power coupling have an interference fit axially through the engagement of the protrusion of the shaft and the relief groove of the power coupling. The shaft and the power coupling also have an interference fit rotationally with polygonal-shaped cross-section for the shaft and the power coupling. In yet another embodiment, a driveshaft manufactured in accordance with the present disclosure avoids inducing unnecessary stress concentrations, as the shaft does not have to be cut or otherwise modified when coupling the shaft to the power couplings within the driveshaft.

While the foregoing is directed to embodiments of the disclosure, other and further embodiments of the disclosure thus may be devised without departing from the basic scope thereof, and the scope thereof is determined by the claims that follow.

1. A multi-component driveshaft, comprising:
a shaft comprising a plurality of layers formed from a continuous fiber with a protrusion positioned upon an interior surface at an end of the shaft; and
a power coupling comprising a relief pocket, the power coupling coupled to the shaft with the protrusion received within the relief pocket.

2. The driveshaft of claim 1, wherein the shaft comprises a second protrusion positioned upon the interior surface at a second end of the shaft, the driveshaft further comprising a second power coupling comprising a second relief pocket, the second power coupling coupled to the shaft with the second protrusion received within the second relief pocket.

3. The driveshaft of claim 1, wherein:
the power coupling further comprises a collar and an end with a non-tapered exterior surface received within the end of the shaft;
the relief pocket is positioned between the collar and the non-tapered exterior surface; and
the relief pocket has a radius or width larger than a radius or width of the collar and the non-tapered exterior surface.

4. The driveshaft of claim 3, wherein the power coupling further comprises a tapered interior surface.

5. The driveshaft of claim 1, wherein the power coupling further comprises splines or a yoke-type coupling.

6. The driveshaft of claim 1, further comprising an adhesive disposed between the power coupling and the shaft.

7. The driveshaft of claim 1, wherein:
the plurality of layers comprises a first helical layer and a second helical layer; and
the first helical layer is disposed at an angle between about 5° and about 85° with respect to an axis of the driveshaft and the second helical layer is disposed at an angle between about 95° and about 175° with respect to the axis of the driveshaft.

8. The driveshaft of claim 1, wherein the continuous fiber comprises a continuous bundle of fibers.

9. The driveshaft of claim 1, wherein the continuous fiber comprises carbon.

10. The driveshaft of claim 1, wherein the shaft comprises a circular-shaped cross-section or a polygonal-shaped cross-section.

11. The driveshaft of claim 1, further comprising:
a track driver positioned about the shaft; and
a support positioned within the shaft that overlaps axially with the track driver with respect to an axis of the shaft.

12. A collapsible mandrel to manufacture a multi-component driveshaft, comprising:
a mandrel core; and
a mandrel shell positioned about the mandrel core and comprising a plurality of segments, at least one of the plurality of segments comprising an interior side proximal the mandrel core and an exterior side distal the mandrel core, the interior side having a surface area or width larger than a surface area or width of the exterior side.

13. The mandrel of claim 12, wherein another one of the plurality of segments comprises an interior side that has a surface area or width smaller than a surface area or width of the exterior side.

14. The mandrel of claim 12, wherein the mandrel shell comprises a collar and a tapered surface formed adjacent the collar.

15. The mandrel of claim 12, wherein the mandrel shell comprises a circular-shaped cross-section or a polygonal-shaped cross-section.

16. A method of manufacturing a multi-component driveshaft, comprising:
positioning a first power coupling and a second power coupling over a mandrel;
applying an adhesive layer to ends of each of the first power coupling and the second power coupling;
winding a continuous fiber between the first power coupling and the second power coupling and over the adhesive layers to form a shaft comprising a plurality of layers from the continuous fiber; and
curing the shaft on the first power coupling and the second power coupling to form the multi-component driveshaft.

17. The method of claim 16, wherein:
the first power coupling comprises a relief pocket formed in an outer surface of the first power coupling; and
the winding the continuous fiber between the first power coupling and the second power coupling comprises winding the continuous fiber within the relief pocket of the first power coupling to form a protrusion on an interior surface at an end of the shaft that is received within the relief pocket of the first power coupling.

18. The method of claim 16, wherein the mandrel comprises a collapsible mandrel, the method further comprising:
removing the collapsible mandrel from the shaft.

19. The method of claim 18, wherein the collapsible mandrel comprises a mandrel core and a mandrel shell comprising a plurality of segments, and wherein the removing the collapsible mandrel comprises:
removing the mandrel core from within the mandrel shell and the shaft; and
removing the plurality of segments of the mandrel shell from within the shaft.

20. The method of claim 16, wherein the mandrel comprises a plurality of support members extending between the first power coupling and the second power coupling with ends of the plurality of support members received within the ends of each of the first power coupling and the second power coupling.
